(19) United States
(12) Patent Application Publication
(10) Pub. No.: US 2026/0150844 A1
(43) Pub. Date: Jun. 4, 2026

(54) Calcium-Enhanced Plants And Methods Therefor

(71) Applicant: Nant Holdins IP, LLC, Culver City, CA (US)

(72) Inventor: Patrick Soon-Shiong, Culver City, CA (US)

(73) Assignee: Nant Holdings IP, LLC, Culver City, CA (US)

(21) Appl. No.: 19/406,581

(22) Filed: Dec. 2, 2025

Related U.S. Application Data
(60) Provisional application No. 63/727,514, filed on Dec. 3, 2024.

(51) Int. Cl. A01N 59/06; A01N 25/12

(52) U.S. Cl. CPC A01N 59/06; A01N 25/12

(57) ABSTRACT

Disclosed herein are micro-sized aragonite compositions and methods for enhancing calcium uptake and overall plant health. The disclosure provides calcium compositions comprising particles of aragonite, preferably oolitic aragonite, that are mechanically reduced to micron or sub-micron dimensions to generate a highly bioavailable, rapidly dissolving calcium source suitable for foliar or soil application. The compositions may be incorporated into liquid suspensions, granules, coated fertilizers, seed treatments, or nutrient delivery systems, and may optionally include biologically active agents, growth stimulants, humates, or surfactants to further promote uptake. Methods of using the compositions to treat calcium deficiency, strengthen cell walls, reduce blossom-end rot, increase stress tolerance, and improve yield are also provided.

This application claims priority to U.S. Provisional patent application with the Ser. No. 63/727,514, filed Dec. 3, 2024, which is incorporated by reference herein.

### FIELD OF THE INVENTION

The field of the invention is increasing calcium concentration in plants, especially as it relates to applying a composition comprising aragonite.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Agricultural productivity has become one of the most urgent challenges facing the modern world. Global population continues to increase at an unprecedented rate, the equivalent of adding a city the size of New York every month, and a country the size of Mexico every year. As a result, demand for food is accelerating dramatically. Yet, despite this accelerating need, millions of people, particularly in developing regions, already suffer from hunger and malnutrition. Current projections indicate that the world must produce as much food in the next 40-80 years as it has in the past 12,000 years combined, and must do so on significantly less available farmland.

At the same time, worldwide cropland availability per capita has been steadily shrinking. The average cropland area per person has decreased from approximately 0.41 ha in 1961 to 0.23 ha in 2002, and further to 0.20 ha by 2021. Compounding the issue, approximately 30% of the world's existing cropland is now unproductive, and nearly 1.5 billion hectares (almost one-third of global cropland) has been abandoned over the past 40 years. Furthermore, even where farmland remains available, pests continue to destroy roughly one-third of global food crops annually. Collectively, these factors underscore an urgent need for technologies that can dramatically improve crop yield, plant resilience, and overall agricultural sustainability.

One critical but often overlooked factor limiting crop productivity is calcium deficiency in plants. Calcium (Ca²⁺) is essential for plant growth, structural integrity, and stress tolerance. When plants lack adequate calcium, they exhibit stunted growth, leaf curling, necrotic leaf veins, poor fruit development, and, in severe cases, complete loss of fruits or vegetables. Calcium deficiency frequently occurs in soils with low cation exchange capacity (CEC), in acidic soils, or in environments where competing ions inhibit calcium uptake.

Conventional solutions for addressing calcium deficiency, such as foliar sprays containing calcium salts, soil amendments like bone meal or wood ash, and, most commonly, agricultural lime, suffer from significant limitations. Foliar sprays and common amendments have low uptake efficiency and require ongoing labor and cost. Lime, although widely used, can take months or years to fully adjust soil pH and requires careful dosing; both under-liming and over-liming can harm soil chemistry and plant health. Additionally, lime mining and processing impose substantial financial and environmental costs, including high carbon dioxide emissions. Thus, despite existing approaches, current calcium supplementation strategies remain inefficient, slow, and environmentally burdensome.

Accordingly, there remains a strong need for improved methods and compositions that can effectively increase calcium concentration in plants, enhance soil health, reduce cost and labor burdens, and support sustainable agricultural expansion.

### SUMMARY OF THE INVENTION

The present disclosure addresses these unmet needs by providing compositions and methods of increasing calcium concentration in a plant, comprising treating the plant with a composition that includes aragonite, specifically microporous oolitic aragonite particles. Aragonite, a naturally occurring polymorph of calcium carbonate with unique microporous and high-surface-area physical properties, offers enhanced calcium bioavailability and improved soil interaction compared to conventional lime.

By utilizing oolitic aragonite particles, the present compositions and methods enable more efficient calcium delivery, faster soil conditioning, and reduced environmental impact relative to traditional calcium-based amendments. This provides a practical and scalable solution to calcium deficiency in plants, thereby contributing to improved crop health and supporting global food production needs.

Therefore, and in one aspect of the inventive subject matter, the present disclosure provides a method of increasing calcium concentration in a plant, the method comprising treating a plant with a composition, wherein the composition comprises aragonite, and wherein the aragonite comprises microporous oolitic aragonite particles.

In a further embodiment, the aragonite particles may have a diameter of at least 3 μm, and in a still further embodiment, the aragonite particles may have a diameter of at least 8 μm.

Further aspects of the disclosed subject matter include treating the plant with the composition by applying the composition at an application rate of at least 120 mL/ha. Yet in other aspects, treating the plant includes applying the composition at an application rate of at least 240 mL/ha. Preferably, the plant is periodically treated with the composition.

In another embodiment, the plant receiving treatment may be a plant that produces root vegetables, legumes, fruits, and/or grains. Alternatively, or in addition, the plant may be a shrub, herb, tree, vine, grass, fern, moss, algae, moss, succulent, and/or an aquatic plant.

In further embodiments, the composition comprises an aqueous solution, but alternatively, the composition may comprise a mineralized composition. As should be readily appreciated, the composition may, in other embodiments, comprise a powder.

Treating the plant with the composition, in other embodiments, may involve spraying the composition directly onto the plant. But in other embodiments, this may involve treating a soil of the plant.

In some embodiments, the composition disclosed herein further comprises magnesium and/or vitamin. Additionally or alternatively the composition may further comprise a fungicide, insecticide, herbicide, fertilizer, and/or another soil amendment.

Moreover, as discussed in detail below, the compositions and/or methods disclosed herein result in less carbon dioxide emission than a method involving or a method of making lime.

In another embodiment the present disclosure provides a method of increasing calcium concentration in a plant-based food, the method comprising applying a composition to a plant, wherein the composition comprises aragonite, wherein the aragonite comprises microporous oolitic aragonite particles, harvesting the plant and incorporating the plant into the plant-based food.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an exemplary bar graph depicting results from measuring the plant height of plants treated with various compositions applied at various rates. The results show no significant differences in terms of plant height.

FIG. 2 is an exemplary bar graph depicting results from measuring the plant aerial DM of plants treated with various compositions applied at various rates. The results show no significant differences in terms of plant aerial DM.

FIG. 3 is an exemplary bar graph depicting results from measuring the root DM of plants treated with various compositions applied at various rates. The results show no significant differences in terms of root DM.

FIG. 4 is an exemplary bar graph illustration depicting results from measuring the Fv/Fm of plants treated with various compositions applied at various rates. The results indicate that Cal-Pher 8 μm (2×) showed a tendency to reduce Fv/Fm compared to Cal-Pher 3 μm (1×) and Cal-Pher 8 μm (1×) on Jul. 6, 2024, while the same was noted for Cal-Pher 8 μm (2×) on Nov. 7, 2024 compared to Cal-Pher 3 μm (1×) and Cal-Pher 3 μm (2×).

FIG. 5 is an exemplary bar graph illustration depicting results from measuring the PI Abs of plants treated with various compositions applied at various rates. The results indicate that Cal-Pher 3 μm (1×) and Cal-Pher 8 μm (1×) showed higher PI Abs values compared to the control as well as the (2×) rates for both treatments.

FIG. 6 is an exemplary bar graph illustration depicting results from measuring the calcium levels in the leaves and the roots of plants treated with various compositions applied at various rates. The results indicate that Cal-Pher 3 μm (1×) treatment showed a 19% higher Ca level in the leaves compared to the control, while the Cal-Pher 3 μm (2×) treatment had a 6% lower Ca level. The Cal-Pher 8 μm (1×) treatment revealed a 6% higher Ca level in the leaves compared to the control, while the Cal-Pher 8 μm (2×) treatment showed no difference from the control. The results also indicate that all Cal-Pher treatments showed an increase in the Ca levels in the roots, with the Cal-Pher 8 μm (2×) revealing the highest level (+40%) compared to that of the control.

FIGS. 7A and 7B are exemplary illustrations of the stability of the oolitic aragonite compositions disclosed herein.

FIG. 8 is an exemplary illustration of tomato plant assessment for plant height and stem diameter.

FIG. 9 is an exemplary illustration of plant vigor scores for tomato and beetroot plants.

FIG. 10 is an exemplary illustration of phytotoxicity scores for tomato and beetroot plants.

FIG. 11 is an exemplary illustration of harvestable yield after treatment with the oolitic aragonite compositions.

FIG. 12 is an exemplary illustration of potential increase in income due to increased yields after treatment with the oolitic aragonite compositions.

FIG. 13 is an exemplary illustration of increase in calcium content of the leaves, roots, and fruit after treatment with the oolitic aragonite compositions.

FIG. 14 is an exemplary illustration of the increase in CA²⁺:Mg²⁺ ratio after treatment with the oolitic aragonite compositions.

FIG. 15 is an exemplary illustration showing the Nitrogen, Potassium, Calcium, Magnesium, in soil and fruits upon treatment with the oolitic aragonite compositions.

FIG. 16 is an exemplary illustration of the Calcium, Nitrogen, Potassium, Calcium, Magnesium, in soil and fruits upon treatment with the presently disclosed oolitic aragonite compositions treatment with the oolitic aragonite compositions.

FIG. 17 is an exemplary illustration an increase in Cation Exchange Capacity (CEC) upon treatment with the oolitic aragonite compositions.

FIG. 18 is an exemplary illustration that the administration of the oolitic aragonite formulations improved water-retention of soil as reflected by the S-value, with the highest concentration having the best effect.

### DETAILED DESCRIPTION

The inventor has unexpectedly discovered that treating a plant with a composition comprising aragonite increases calcium concentration in the plant, preferably wherein the aragonite comprises microporous oolitic aragonite particles. Most significantly, the inventor has discovered that oolitic aragonite provides superior drainability, cooling (via reflectivity and water evaporation properties), dimensional stability in a layer, and ammonia neutralization capabilities (which is especially desirable where pet or other animal waste is present). See patent application Ser. No. 17/098,097, which is incorporated by reference herein. Treating the plant with such composition comprising aragonite may involve directly treating the plant's roots, leaves, stems, flowers, seeds, and/or botanical products (fruits, vegetables, etc.), or treating the soil of the plant with the composition.

Aragonite is a substance formed naturally in all mollusk shells and in the calcareous endoskeletons of warm- and cold-water algae and corals. Aragonite also accumulates as inorganic precipitates from marine cements in the ocean. While aragonite shares the same chemistry with calcite, aragonite is a polymorph of calcite having different symmetry and crystal structure from calcite. For example, in aragonite, the carbonate ions lie in two planes that point in opposite directions. This bi-planar configuration destroys the trigonal symmetry that is characteristic of calcite's structure. Aragonite's bi-planar structure gives rise, in turn, to aragonite's orthorhombic symmetry and relative instability at high temperature. Amorphous calcium carbonate can form into aragonite in specific conditions (e.g., coral-growing conditions, etc.). Such formed aragonite provides benefits being more resistant in shear stress and lower pH conditions.

Among other processes, aragonite may be reduced in size (e.g., micronized an average particle size of less than 1 mm, or equal or less than 500 μm, or equal or less than 300 μm, or equal or less than 100 μm, or equal or less than 50 μm, or equal or less than 25 μm, or equal or less than 10 μm, or equal or less than 8 μm, or between 3 μm to 8 μm), colored with one or more dyes or pigments, coated or otherwise treated with antimicrobial agents and/or scented agents, or impregnated or coated with one or more agriculturally relevant agents or chemicals (e.g., fungicide, insecticide, herbicide, fertilizer, etc.). Still further modifications include restructuring of aragonite as is described in WO 2020/150274 (U.S. 62/792,735), which is incorporated by reference herein. Likewise, the aragonite may also be reduced in size while retaining its oolitic shape, typically using a ball mill process. Thus, suitable milled aragonite may include oolitic aragonite having an average particle size of between 3-5 μm, or between 3-8 μm, or between 3-10 μm, or between 3-20 μm, or between 20-50 μm, or between 50-200 μm, or between 200-500 μm, or between 500-700 μm. Notably, such micronized particles will still retain the benefits as noted herein.

The aragonite particles as used herein may, in some embodiments, be spherical, irregular, amorphous, or structured in shape. However, in preferred embodiments, the aragonite comprises microporous oolitic aragonite particles.

The inventor further discloses a composition comprising aragonite and a spheroid fatty acid-based nano and microparticle delivery system designed to increase uptake of calcium and other mineral components found in aragonite. The inventor additionally discloses an enhanced delivery system of such composition comprising a large-scale spray, wherein the large-scale spray may be applied to plants via aerial and/or drone spraying. An exemplary embodiment of aragonite as disclosed herein comprises biogenic calcium carbonate derived from oolitic aragonite sand.

Oolitic aragonite is a versatile resource that provides several benefits over standard mined calcium carbonate or limestone. The unique microporous structure affords it many benefits, including but not limited to, higher surface area, high negative zeta potential, and high calcium bioavailability. The Oolitic aragonite of the present disclosure offers various particle sizes from nanometers to 8 μm. Preferred embodiments may comprise a 3 μm to 8 μm particle size incorporated by and within a fatty acid-based nano and/or microparticle delivery system (such as Pheroid®-based microparticles). The use of a fatty acid-based nano and/or microparticle delivery system to deliver the oolitic aragonite aids in the uptake of the minerals including calcium by plants.

The spheroid fatty acid-based nano and/or microparticle delivery system used herein may be a Pheroid®, which refers to a proprietary nano- and micro-emulsion delivery system comprising lipid-based vesicles, micelles, and submicron colloidal structures capable of encapsulating, solubilizing, and transporting a wide range of biological, chemical, and inorganic molecules. In other embodiments, the spheroid fatty acid-based nano and/or microparticle delivery system may comprise of a mixture of essential fatty acids, natural oils, antioxidants, surfactants, and emulsifiers that self-assemble into amphiphilic vesicular structures when dispersed in an aqueous environment. These structures form micro- and nano-sized carriers that enhance the absorption, penetration, and systemic movement of active agents across biological barriers.

In agricultural applications, the spheroid fatty acid-based nano and/or microparticle delivery system of the present disclosure may be combined with an oolitic aragonite. Such a system function as a plant-compatible carrier system that: (i) promotes foliar and root uptake of nutrients and other molecules; (ii) enhances translocation of compounds that are naturally immobile in plants, such as Ca²⁺; (iii) increases dispersion and stability of insoluble or poorly soluble particles (e.g., aragonite microparticles); and (iv) improves bioavailability and delivery efficiency through carrier-mediated transport into plant tissues. It should be recognized that the presently disclosed formulations provide a biologically inert, biodegradable, and non-phytotoxic vehicle for repeated agricultural use.

In some embodiments, the oolitic aragonite may be present in an emulsion with AnnGro®, which is a product based on the Pheroid® technology. For example, the soil amendment composition disclosed herein may comprise a granular or slurry formulation comprising oolitic aragonite particles (average diameter˜1-10 μm) dispersed in a spheroid fatty acid-based nano and/or microparticle delivery system, wherein the delivery system is present in a concentration sufficient to stabilize the aragonite suspension. Optionally, the formulation may also include additional nutrients (e.g., micronutrients such as Mg²⁺, Fe, Zn) dissolved or suspended in the oolitic aragonite formulation.

The oolitic aragonite compositions of the present disclosure may be used by mixing into potting soil or field soil prior to planting, thereby gradually releasing Ca²⁺ as aragonite dissolves and enabling improved root uptake. Alternatively, the oolitic aragonite compositions may also be formulated as a foliar spray and applied to young leaves at critical growth stages (e.g., meristematic tissues, rapidly elongating leaves), promoting cuticular penetration of Ca²⁺.

In some embodiments, the oolitic aragonite compositions are formulated for coating a seed. Such a formulation is contemplated to further comprise a film-former or binder (e.g., biodegradable polymer) to adhere the oolitic aragonite to seed surfaces. Optional protective additives (e.g., anti-UV stabilizer, antioxidant) may also be used to maintain viability. During germination of the thusly treated seeds, the Ca²⁺ will be slowly released near the radicle, improving root tip health, early vigor, and reducing calcium-deficiency in seedlings.

In further embodiments, the oolitic aragonite compositions are formulated as controlled-release pellet or granule. In this formulation, the oolitic aragonite is designed to release Ca²⁺ over weeks or months in the soil, thereby enhancing long-term soil calcium availability.

It should be recognized that the presently disclosed oolitic aragonite compositions provide several advantages over using calcite. For example, unlike calcite, oolitic aragonite dissolves more rapidly at mildly acidic to neutral pH (5.5-6.8), which is precisely the pH range of most agricultural soils. Thus, the plants receive bioavailable Ca²⁺ without requiring strong acidification or microbial conversion, enabling rapid correction of hidden calcium deficiency.

Furthermore, the spherical microstructure enables superior soil flow and micro-placement. Oolitic aragonite is composed of uniform, spherical micro-grains, unlike crushed limestone (irregular, jagged particles). These spheres self-organize in soil pores, infiltrating microchannels around root hairs and root tips, creating better physical contact and improving Ca²⁺ transfer efficiency. Moreover, the oolitic aragonite reduce soil pH shock. Traditional liming materials can spike soil pH and stress plants. Aragonite dissolves more gently and uniformly, reducing sudden alkalization. Thus, calcium can be delivered without disrupting nutrient availability of micronutrients like Fe, Mn, or Zn that are lost at high pH.

For additional information and further uses of aragonite, see international patent application No. PCT/US2020/013562 which is incorporated by reference herein. Further, see the US published application with Pub. No. US 2022/0047474A1, which is incorporated by reference herein. Also see U.S. application Ser. No. 17/423,279, which was filed as application No. PCT/US2020/013562, and U.S. provisional application 63/233,660, filed on Aug. 16, 2021, provisional application No. 62/874,253, filed on Jul. 15, 2019, provisional application No. 62/867,489, filed on Jun. 27, 2019, and provisional application No. 62/792,735, filed on Jan. 15, 2019, all of which are incorporated by reference herein.

In certain embodiments, the composition comprises aragonite particles having a diameter in the range of about 0.1 μm to about 10,000 μm, or about 1 μm to about 500 μm, and in more typical embodiments, about 3 μm to about 100 μm. As will be readily appreciated, the aragonite particles may have a diameter of at least 0.1 μm, at least 3 μm, at least 8 μm, at least 16 μm, at least 32 μm, at least 50 μm, or at least 100 μm.

The composition disclosed herein may comprise an aqueous solution, for example, with the aragonite particles being suspended in a liquid carrier, such as water, and applied at rates ranging from about 10 milliliters per hectare (mL/ha) to about 1,000 liters or more per hectare (L/ha), with a preferred range of about 10 mL/ha to about 50 L/ha, and an exemplary application rate of 120 mL/ha and 240 mL/ha.

Furthermore, the application rate for treating the plant may be periodic. For instance, and in other embodiments, treating a plant with the composition may comprise applying the composition to the soil of the plant at intervals ranging from about 1 hour to about 5 years, or at intervals ranging from about 1 day to about 6 months, or at intervals ranging from about 7 days to about 60 days, depending on the intended use. As such, application may comprise spraying, dripping, irrigating, dousing, etc.

Application rates may vary across intervals, with an initial application delivering about 1 mL/ha to about 1,000 L/ha for liquid compositions, or about 0.01 kg/ha to about 1,000 kg/ha for solid compositions. For example, periodic application may involve an initial application of the composition at 120 mL/ha on Day 0, followed by reduced application rates of 50 mL/ha every 14 days for a total of four applications over 56 days. Alternatively, another periodic application may involve applying 200 mL/ha of liquid composition 7 days before planting, 100 mL/ha every 10 days during the early growth stage, 300 mL/ha every 15 days during the mid-growth stage, and a final application of 50 mL/ha 5 days before harvest. A still further exemplary periodic application may involve an initial application rate of 120 mL/ha at 25 days, followed by a second application rate of 240 mL/ha at 44 days, followed by a third application rate of 240 mL/ha at 59 days, followed by no application of the composition until harvest.

In further embodiments disclosed herein, the composition comprises a mineralized composition or a rock powder. In such compositions, applied as a dry and/or wet solid, the composition may be applied in application rates ranging from about 0.01 kilograms per hectare (kg/ha) to about 1,000 kg/ha, or at a range of about 1 kg/ha to about 100 kg/ha. In other embodiments, the composition is applied at an application rate ranging from about 1 particle of composition or aragonite particles per square meter to 1,000,000,000 particles of composition or aragonite particles per square meter, or at a range of about 1,000 particles of composition or aragonite particles per square meter to 1,000,000 particles per square meter. In yet further aspects, the composition may be applied to land areas ranging from 1 square centimeter to about 10,000 hectares.

It should be appreciated that application rate and/or particle size of a treatment can be adjusted depending on the particular properties and/or deficiencies of the plant receiving treatment. For example, plants that produce oats, green leafy vegetables, legumes, chia seeds, and/or other plants are naturally richer in calcium concentration, and therefore is treated with a lower application rate of the composition accordingly. In parallel, plants that naturally have lower calcium concentrations, such as plants that produce lettuce, tomato, peppers, apples, tobacco, certain flowers, and/or other plants low in calcium, and/or plants that are more susceptible to calcium-deficiency, may be treated with a higher application rate of the composition. Regardless of the natural calcium concentration of the plant receiving the treatment, the plant may receive an application rate based on a desired calcium concentration of the plant's yield. For example, the methods and compositions disclosed herein is beneficial for enhancing the calcium concentration of fruits, vegetables, and/or any other food yield, or to produce plant-based foods with higher calcium concentrations. Examples of plant-based foods are plant-based oils (olive oil, avocado oil, etc.), plant milk (soy milk, almond milk, oat milk, etc.), tofu-based meats, cheeses and chocolates including nuts, rice cakes, peanut butter products, hummus, kombucha, etc.

In addition, the methods and compositions disclosed herein are beneficial for increasing calcium concentration in an animal, especially herbivores and graminivores that graze on grass or other plants. In turn, and especially as it relates to livestock animals, the disclosed methods and compositions are beneficial for increasing calcium concentration in meat and/or meat-based foods.

In some embodiments, the plant treated with the composition is a plant that produces root vegetables (e.g., turnips, carrots, etc.), legumes (e.g., beans, peanuts, soybeans, etc.), fruits (e.g., tree-based, vine-based, strawberries, nuts, etc.), grains (e.g., rice, wheat, barley, corn, etc.), and/or other botanical products.

Where it is recited that calcium concentration is increased in a plant, the inventor contemplates that calcium concentration may be quantified or measured by different techniques. For example, calcium concentration may refer to increase calcium uptake, elevated calcium concentration in plant tissues overall, elevated storage of calcium in particular tissues, enhanced ability to retain calcium, elevated bioavailability of calcium, increased diffusion of calcium ions across a membrane of a root of the plant, increased cation exchange of calcium ions into the plant, enhanced calcium uptake through a stem of a plant to its leaves, or any other technique.

The use of aragonite as disclosed herein provides several unexpected advantages. For example, aragonite applied to plants exhibits a better uptake rate than alternatives such as limestone. As a result, the use of aragonite demonstrates measurable benefits in a plant sooner than limestone or other alternatives. Further, because the aragonite of the presently disclosed compositions are of micrometer size (3-8 μm in diameter) they demonstrate better mobility. The mobility of a nutrient may determine the methods in which the nutrient can be absorbed into a plant, especially where mobility describes a nutrient's ability to move through soil. For example, a larger molecule like phosphorous with limited mobility may only be able to enter a plant via diffusion. Meanwhile, aragonite particles may enter the plant via diffusion, cation exchange, mass transport through water, and leaf transpiration, among other methods where mobility is a factor. These benefits are especially observed during leaf transpiration whereby the leaves of a plant evaporate water into the atmosphere and draw in water from the stem, wherein the water comprises nutrients including calcium.

Further, aragonite in plants provides numerous other benefits by increasing calcium concentration in a plant such as enhanced soil pH optimization, enhanced promotion of the microbial environment in soil, increased moisture in soil, enhanced compatibility with other nutrients and biostimulants, and enhanced temperature regulation of soil. Additionally, it is contemplated that aragonite may exhibit beneficial antibacterial properties. Further, aragonite provides enhanced resistance to water penetration in soil, which may be especially advantageous in climates where excessive moisture in soil decreases or removes the availability of nutrients in the soil. In a further embodiment, aragonite is more resistant to being removed or washed away by excessive water than its alternatives in the prior art.

Plants primarily absorb nutrients through their roots, supported by root hairs on the root tips which significantly increase the surface area for nutrient absorption. The root hairs typically grow around aggregates of nutrients including aragonite. Leaf transpiration may create a suction on the water at the root surface that draws the nutritious surface soil solution toward the plant roots, allowing nutrients such as calcium to move toward the roots through a vapor pressure deficit. Then, when the nutrients reach the root hairs, carriers on the cell walls of the roots are contemplated to recognize each specific nutrient ion, including calcium, magnesium, copper, zinc, etc., allowing plants to be selective about the nature of ions admitted into the plant roots. By this point, the leaf transpiration has caused a negative pressure in the xylem of the plant since water has evaporated from the leaf surface, and this negative pressure pulls water upward through the plant, from roots to leaves, via the cohesion and adhesion of water molecules (see e.g., Thomas A. Ruehr, Professor, Earth and Soil Sciences Department, Cal Poly State University, San Luis Obispo, CA 93407-0261. Adapted from Vegetables West magazine).

The inventor has found that the properties of oolitic aragonite particles enhances the efficiency of this process. For example, the aragonite particles allow calcium to bind to the carriers on the roots at lower vapor pressure deficits than would its alternatives. This may be a result of the small size of the aragonite particles, or potentially the various shapes to which aragonite may be adapted. For example, a smaller particle may require less energy for the plant to absorb, and/or the configuration of the carrier may be more compatible with the shape of the aragonite particles to allow higher binding affinities. In further aspects, the pH optimization qualities of aragonite allows for the more effective uptake of positively charged ions into the plant. These pH optimization qualities allows a user to adjust the amount or concentration of aragonite in a composition based on the desired pH condition of a plant.

Although aragonite is used as a soil conditioner in the art, the particular benefits of using microporous oolitic aragonite particles, especially modified aragonite particles having reduced sizes, were not well understood before this disclosure.

The micro-sized oolitic aragonite particles of the present disclosure, particularly 3 μm-8 μm microporous aragonite, is used as a biologically active calcium supplement to directly enhance plant calcium uptake, improve physiological calcium distribution, and increase yield and plant vigor. Aragonite is a crystallographically distinct polymorph of calcium carbonate with higher solubility, needle-like morphology, and significantly greater bioavailability than calcite or lime cake materials. The present disclosure specifically employs engineered microporous oolitic aragonite capable of releasing bioavailable Ca²⁺ under physiological soil conditions and delivering this calcium efficiently into root and foliar tissues.

Embodiments of the present disclosure are further described by the following examples. It should be noted that that these examples are merely illustrative and not limiting.

### Example 1

An exemplary trial was conducted under net house conditions covered with 40% grey shading net. Irrigation was supplied using controlled drip irrigation. Plastic pots (Description: POT PC 30 cm TC; Code: PC01300) with a surface area of 0.084 m² were filled with a Bainsvlei type soil. Twelve wheat seeds were planted and thinned out to 8 seedlings per pot. With plant, each pot received 2.5 g kynoplus 6:2:1 broadly applied to the soil. At the tillering stage each pot received again 2.5 g kynoplus 6:2:1 and one-week later LiQuiDo Base applied at 10 L/ha to supply essential micro-nutrients.

An insecticide was sprayed at a rate of 12.5 ml per 10 L water to control pests. The crop grown was wheat (Triticum aestivum, Variety: Scheepers), with 12 seeds planted per pot.

A composition comprising oolitic aragonite (or oolitic aragonite plus Pheroid) was applied to the crops as described below:

TABLE 1
Times of applications of CalceanCal-Pheroid (oolitic
aragonite is also referred to here as CalceanCal)

| Application | Date | Growth Stage |
|---|---|---|
| 1^{st} | May 31, 2024 | 4-5 leaves |
| 2^{nd} | Jun. 18, 2024 | 7-8 leaves |
| 3rd | Jul. 4, 2024 | Tillering |

The oolitic aragonite composition was applied using an electronic knapsack sprayer (EZ spray; 16 L), equipped with an ASJ 110 02 yellow Flat fan nozzle. Spray pressure was set at 4 bar; Spraying width: a single nozzle at a height of 0.5 m above target area was used with a spray width of 0.5 m; Application volume: 200 L/ha.

The experiments were done with two different sizes of aragonite particles, and two different application rates, as shown in the table below. Treatment 1 represents the control group:

TABLE 2
Treatments

| | | Oolitic Aragonite | Oolitic aragonite |
|---|---|---|---|
| Treatment | Application rate | 3 um (ml/ha) | 8 um (ml/ha) |
| 1 | | | |
| 2 | 1x | 120 | |
| 3 | 2x | 240 | |
| 4 | 1x | | 120 |
| 5 | 2x | | 240 |

*AnnGro was pre-formulated with the oolitic aragonite.

10 replicates were evaluated. The experiment was conducted with 36 degrees of freedom. There were 5 treatments and 10 replicates (Rep). The interaction term is represented by (t−1)(r−1)=≥36

The various metrics were assessed as follows:

Aerial and root dry mass (DM): Each replicate was harvested by hand and divided into plant aerial and root parts. Plant material was dried in an oven at 65° C. After the drying period, the plant aerial and root DM were measured separately.

Chlorophyll fluorescence: One week after each treatment application the chlorophyll fluorescence of the newest fully developed leave was measured using the Pocket PEA

Chlorophyll Fluorimeter. Variable Fluorescence/Maximum Fluorescence (Fv/Fm) and Performance Index absorption (PI Abs) was measured.

Plant height: Plant height of each replicate was measured 7 Days After Application (DAA) on every application date.

Leaf and root analysis for nutrient content: Roots and leaves of 5 replicates were combined for each treatment on the date of harvest and was send for tissue analysis at SGS laboratories.

Phytotoxicity and plant vigor: The level of phytotoxicity and plant vigor was measured 7 days after each application date using the BBA Phytotoxicity Rating Scale and Plant vigor rating scale according to Aryantha et al. (2000).

To evaluate the crop phytotoxicity statistically, the BBA rating scale was used. Raw data may be subjected to analysis of variance using the NCSS 2000 (BMDP Statistical Software Inc., Los Angeles, CA) statistical program and means may be compared using the Fischer's Multiple-Comparison Test. Significance in data were expressed as LSD values, where differences at P<0.1 were considered significant.

For some metrics, such as plant height, plant aerial DM, and Root DM, there were no significant differences between treatment and control. However, for other metrics, significant differences were observed between treatment and control. In addition, significant differences were observed between compositions comprising aragonite particles having a diameter of 3 μm and those having a diameter of 8 μm. Further, differences were observed between treatments with the application rate of 1× and 2×.

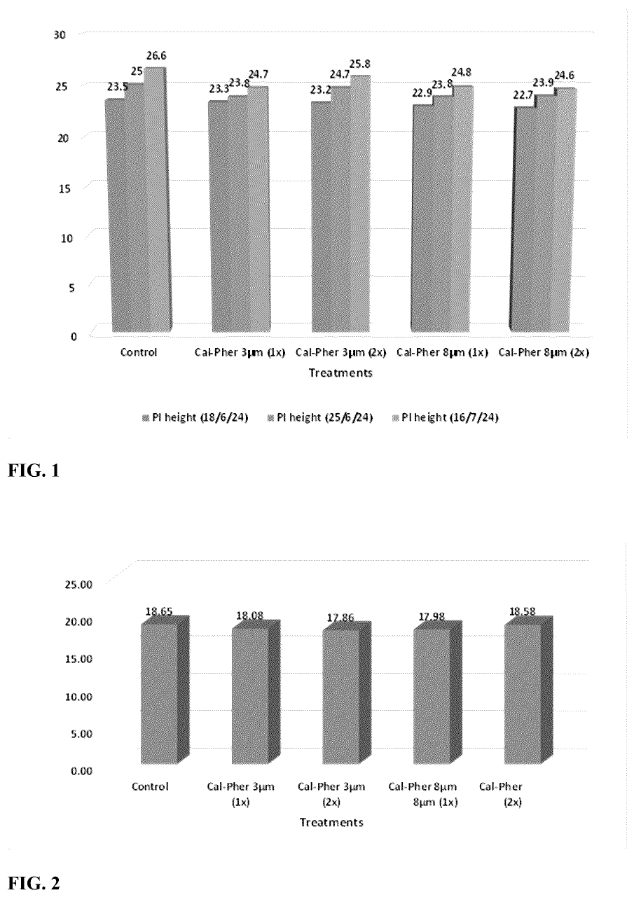

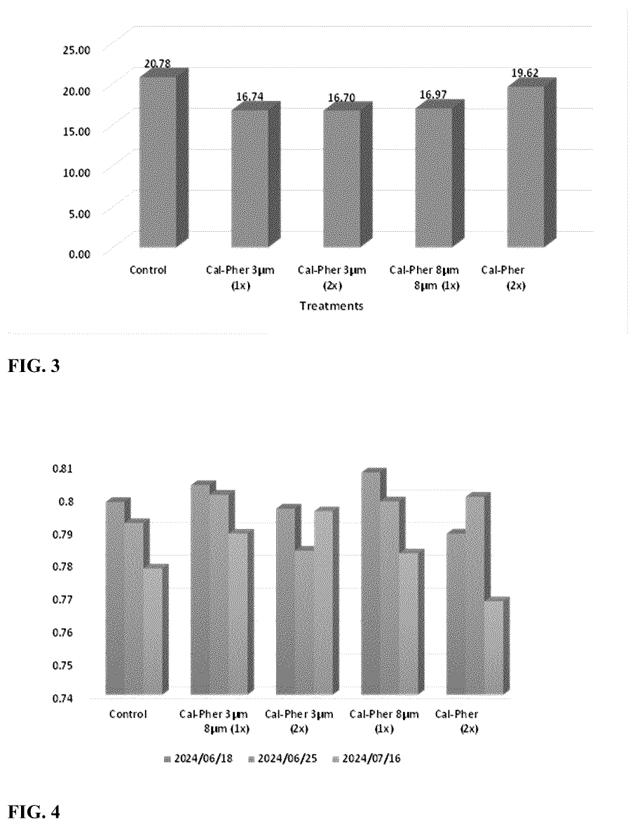

Seven days after each application the plant height was measured. Treatments showed no significant differences in terms of plant height (FIG. 1). Furthermore, no significant differences were noted between treatments in terms of plant aerial DM (FIG. 2) or root DM (FIG. 3). Treatments containing Cal-Pher (oolitic aragonite plus pheroid) showed a tendency to decrease root DM, except for the Cal-pher 8 μm.

Chlorophyll fluorescence (Fv/Fm): Fv/Fm measures if plant stress affects photosystem II in a dark-adapted condition. The difference between maximum fluorescence and minimum fluorescence is Fv, or variable fluorescence. Fv/Fm is a normalized ratio created by dividing variable fluorescence by maximum fluorescence. It is a measurement ratio that represents the maximum potential quantum efficiency of Photosystem II if all capable reaction centres were open. Optimum values for the Fv/Fm ratio range between 0.79 and 0.84, values lower than this threshold can indicate plant stress. Based on the results shown in FIG. 4, all the treatment values were between 0.79 and 0.84, indicating that the plants were not under a stress condition due to treatment applications. Cal-Pher 8 μm (2×) showed a tendency to reduce Fv/Fm compared to Cal-Pher 3 μm (1×) and Cal-Pher 8 μm (1×) on Jul. 6, 2024, while the same was noted for Cal-Pher 8 μm (2×) on Nov. 7, 2024 compared to Cal-Pher 3 μm (1×) and Cal-Pher 3 μm (2×).

Chlorophyll fluorescence (PI Abs): PI Abs provides a comprehensive measure of the plant's photosynthetic performance by considering how well absorbed light is used for photosynthesis. It can be used to evaluate plant health, stress responses, and overall photosynthetic efficiency. A PI Abs value closest to 10 is an indication of a very effective photosynthesis rate. Treatment 2 (Cal-Pher 3 μm; 1×) and Treatment 4 (Cal-Pher 8 μm; 1×) showed higher PI Abs values compared to the control as well as the (2×) rates for both treatments (FIG. 5).

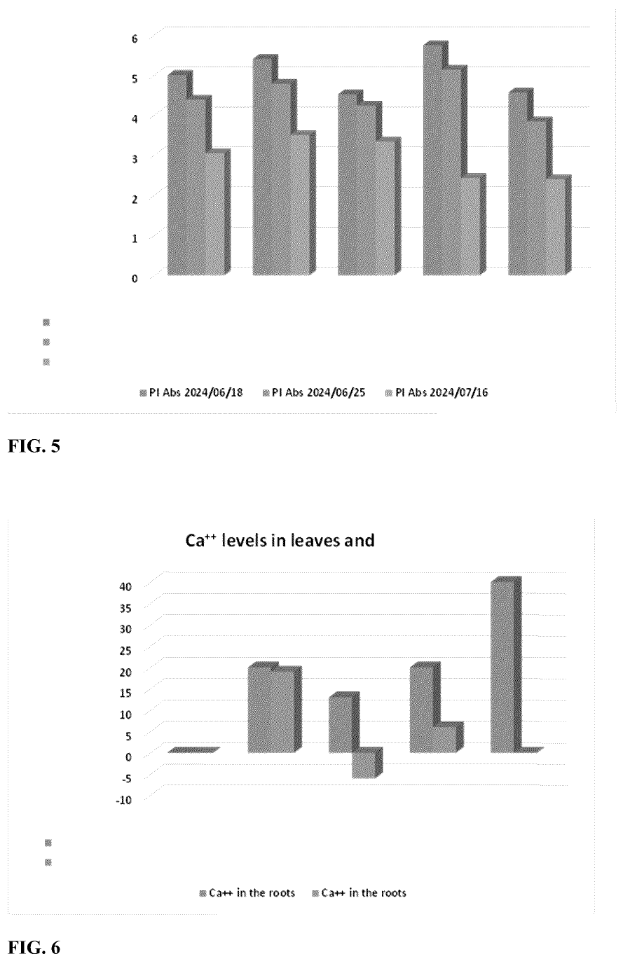

Leaf and root analysis. The Cal-Pher 3 μm (1×) treatment showed a 19% higher Ca level in the leaves compared to the control, while the Cal-Pher 3 μm (2×) treatment had a 6% lower Ca level (FIG. 6). The Cal-Pher 8 μm (1×) treatment revealed a 6% higher Ca level in the leaves compared to the control, while the Cal-Pher 8 μm (2×) treatment showed no difference from the control. All the Cal-Pher treatments showed an increase in the Ca levels in the roots. The Cal-Pher 8 μm (2×) revealed the highest level (+40%) compared to that of the control.

Phytotoxicity and plant vigor. None of the treatments showed any phytotoxicity symptoms or negative effects in terms of plant vigor 7 days after each of the 3 application dates.

In conclusion, from the above results, although higher Calcium levels were detected in the roots of all Cal-Pher treatments, as well as in the leaves, these treatments did not reveal a significant effect on physiological and morphological parameters measured in this specific study. Calcium is an essential element in plants and serves as a constituent of cell walls and membranes and thus contributes to the structure of cells and the upholding of physical barriers against pathogens. It is not mainly responsible for plant vigor. The higher Calcium levels obtained in the roots are very promising since it is normally difficult for Calcium to move from aerial plant parts to the roots.

### Example 2: Aragonite-Pheroid Compositions and their Agricultural Effects

The present example describes agricultural compositions and methods utilizing aragonite in combination with Pheroid delivery technology to improve plant calcium uptake, vigor, photosynthetic performance, yield quantity and quality, and overall soil conditioning. The combined formulation, referred to herein as Aragonite-Pheroid (ARA-Pher or Cal-Pher, which terms are used interchangeably), was evaluated in two greenhouse studies involving foliar administration to wheat and soil administration to tomato (Solanum lycopersicum) and beetroot (Beta vulgaris). The objectives of the experiments were to enhance plant vigor, improve photosynthetic activity, elevate calcium concentrations within plant tissues, increase harvestable yield, and prevent calcium deficiency and related physiological disorders. Calcium (Ca²⁺) plays a fundamental role in regulating cell division and elongation, enzyme activation, plasma membrane stability, cell wall structure via calcium-pectate crosslinking, and intracellular signaling as a secondary messenger.

Because calcium is largely immobile once deposited in tissues, deficiency symptoms manifest in actively growing regions such as apical meristems, expanding leaves, root tips, and developing fruits. Root uptake of ionic Ca²⁺ is influenced by soil pH, cation exchange capacity (CEC), moisture levels, organic matter content, and competition from other cations including Mg²⁺, K⁺, and Na⁺, while foliar uptake is inherently limited. Calcium deficiency commonly results in stunted growth, reduced node formation, diminished leaf area, necrotic lesions, and distorted young leaves with darkened veins. In crop-specific manifestations, wheat exhibits leaf curling, brown edges, and tip necrosis, whereas tomatoes display blossom-end rot characterized by sunken necrotic tissue at the distal fruit end, and beetroot shows reduced leaf area and internal tissue defects, including “sticky centers” under drought stress conditions.

Pheroid is a nano- and micro-emulsion-based delivery platform originally developed for pharmaceutical and agricultural applications and consisting of lipid-based vesicles, micelles, and submicron colloidal carriers derived from essential fatty acids, natural oils, antioxidants, and emulsifiers. These amphiphilic structures range from approximately 100 nm to several micrometers in size and are capable of encapsulating hydrophilic, hydrophobic, and inorganic compounds while enhancing dispersion stability and transport across biological membranes, including plant cuticles. Pheroid has been shown to facilitate penetration and systemic translocation of otherwise poorly mobile ions such as Ca²⁺ and to enhance overall nutrient bioavailability in plants. Oolitic aragonite possesses higher solubility than calcite, and high surface area, particularly when utilized as microporous oolitic particles. When combined with Pheroid, the resulting ARA-Pher compositions increase calcium solubility, bioavailability, and mobility within plant tissues.

Greenhouse experiments were conducted in a solid-panel agricultural greenhouse equipped with ventilation fans. Plants were manually irrigated with uniform water volumes per pot. Tomato plants were cultivated in 10-kg pots and beetroot in 4.5-kg pots, each containing Hutton-type soil and one plant per pot. A randomized block design was employed with ten treatments, ten replicates per treatment, and at least eighty-one degrees of freedom. Baseline soil analyses, including pH (KCl), P, Ca, Mg, K, Na, S, exchangeable acidity, soil density, cation ratios, and S- and T-values, were performed by SGS. Planting occurred on 27 Feb. 2025, with beetroot harvested on 28 May 2025 and tomatoes on 16 Jun. 2025. Multifeed Classic 5:2:4 fertilizer, selected for its high phosphorus content and absence of calcium, was applied at a 5 g/2 L dilution on designated fertilization days, replacing standard irrigation.

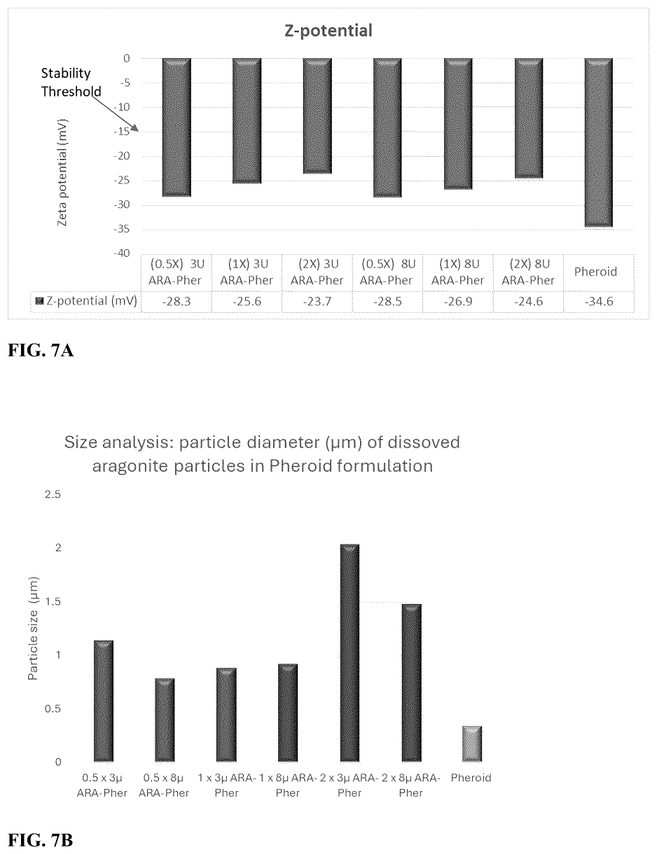

ARA-Pher formulations contained aragonite particles of either 3 μm or 8 μm, combined with Pheroid. Three doses were tested: 0.5×, 1×, and 2× of the standard ARA-Pher formulation. Soil-applied doses for tomatoes were 42, 84, and 168 mg/kg soil for the 3 μm and 8 μm particles; beetroot doses were 60, 120, and 240 mg/kg soil for the 3 μm and 8 μm particles. Pheroid-only and untreated controls were included. The formulations were stable throughout the study, with stability decreasing at higher particle sizes and concentrations (FIG. 7A). Notably, aragonite particles partially dissolved within the Pheroid matrix, decreasing effective particle size during storage (FIG. 7B). Formulation pH values ranged from 9.25 to 9.63 for ARA-Pher samples and 5.8 for Pheroid alone.

| Particle size | Dose | Tomatoes | Beetroot | |
|---|---|---|---|---|
| 3 μm | 0.5 x ARA-Pher | 42 mg/kg soil | 60 | mg/kg soil |
| | 1 x ARA-Pher | 84 mg/kg soil | 120 | mg/kg |
| | 2 x ARA-Pher | 168 mg/kg soil | 240 | mg/kg soil |
| 8 μm | 0.5 x ARA-Pher | 42 mg/kg soil | 60 | mg/kg soil |
| | 1 x ARA-Pher | 84 mg/kg soil | 120 | mg/kg |
| | 2 x ARA-Pher | 168 mg/kg soil | 240 | mg/kg soil |

| | | | |
|---|---|---|---|
| Pheroid | 1x Pher | — | — |
| Control | | — | — |

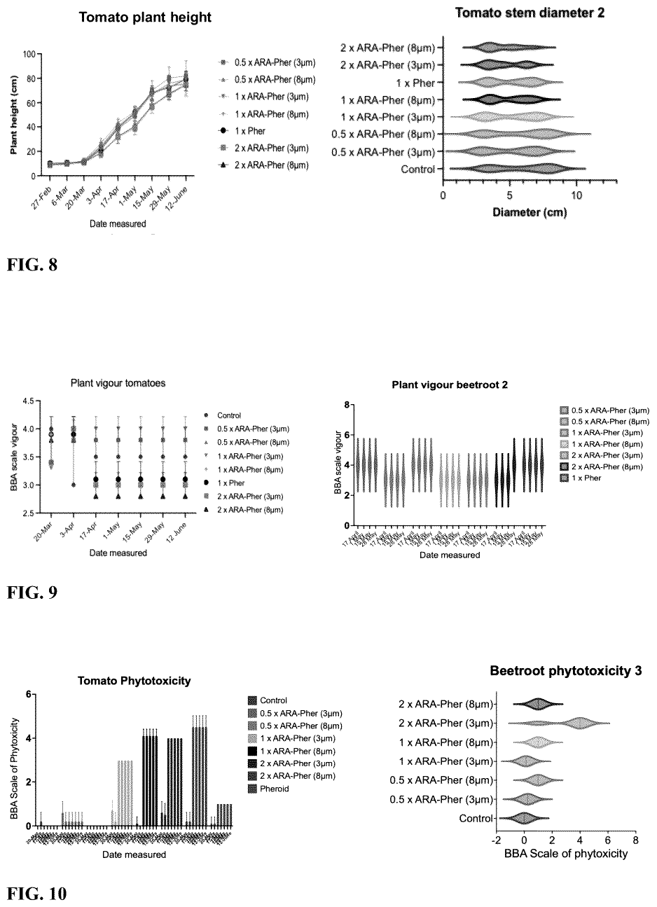

Plants were assessed every 14 days for height, stem diameter measured 5 cm above the soil surface using a vernier caliper (FIG. 8), and phytotoxicity and vigor scores (FIG. 9, 10) based on the BBA phytotoxicity scale (Aryantha et al., 2000). At harvest, fresh aerial and root biomasses were recorded. Composite tissue analyses evaluated N, P, K, Ca, Mg, Na, Mn, Fe, Cu, Zn, B, S, and Mo concentrations, and moisture content was determined for whole fruit or tuber samples. Statistical analyses were performed using ANOVA (NCSS 2000 or Prism), with Fisher's Multiple-Comparison Test applied and significance defined as P<0.1.

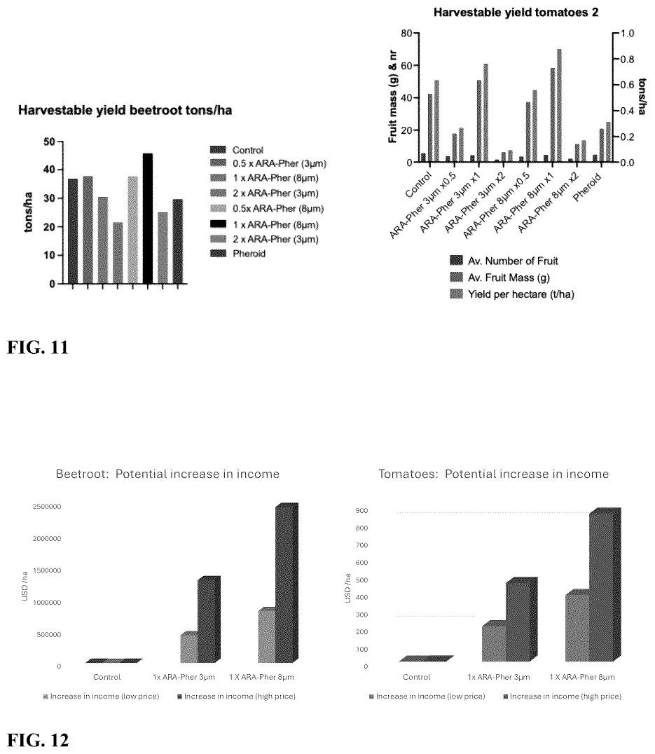

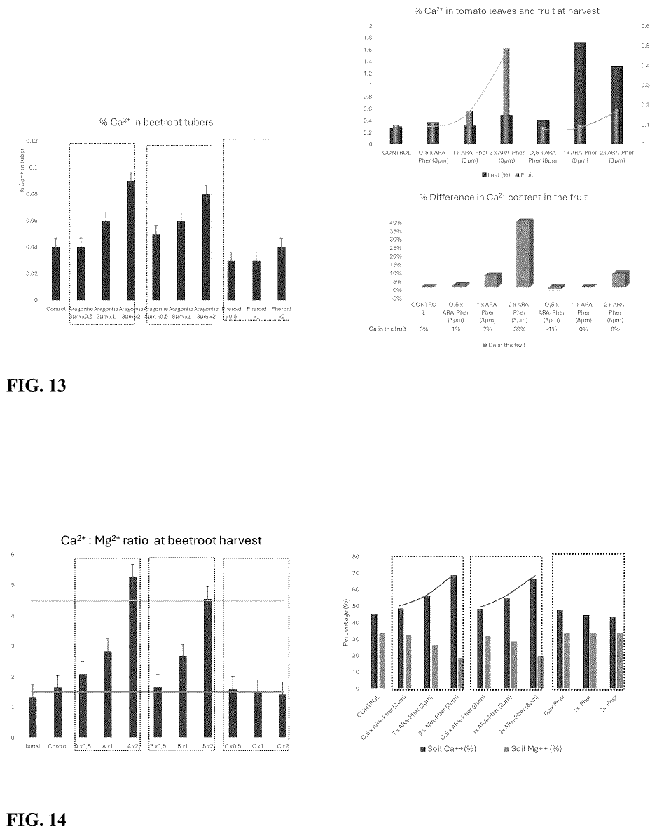

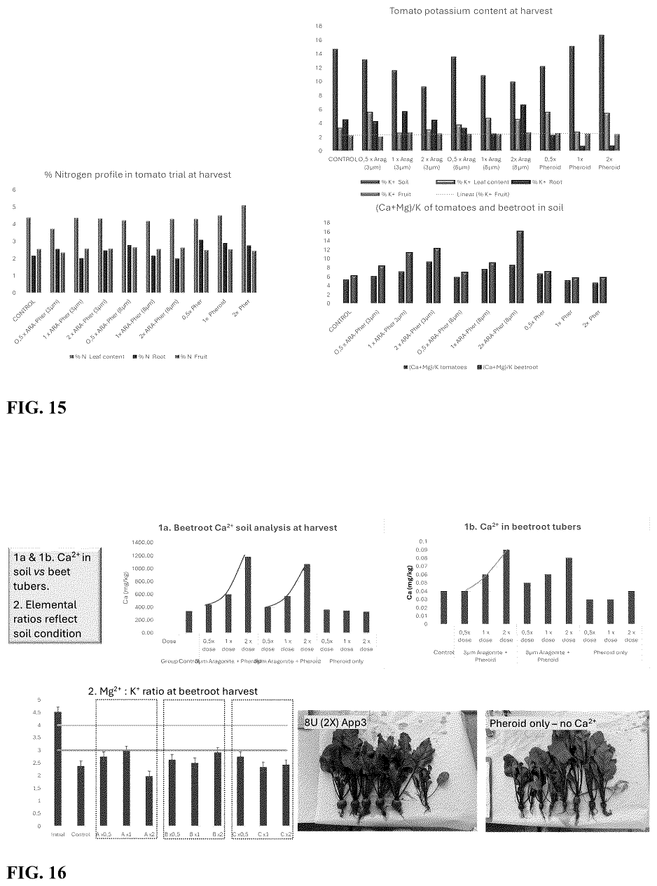

The results demonstrated that calcium administration increased stem height and diameter, with higher Ca²⁺ concentrations producing greater responses. Aragonite particle size influenced plant vigor substantially, with both 3 μm and 8 μm particles producing improved outcomes relative to controls. Phytotoxicity exhibited a concentration-dependent pattern but remained within acceptable thresholds. Yield improvements were significant: ARA-Pher increased yield across all crops, with 1×ARA-Pher producing approximately 40% yield increases, exceeding typical 10-30% gains from conventional calcium supplementation (FIG. 11, 12). In tomatoes, calcium content increased by 39% at the 2× dose (FIG. 13). Soil conditioning effects included marked improvement of Ca²⁺:Mg²⁺ ratios (FIG. 14), enhanced soil structure, improved aeration, superior water infiltration, and enhanced nutrient availability. Physiological disorders associated with calcium deficiency were not observed; no blossom-end rot occurred in tomatoes at any dose, and beetroot did not exhibit “sticky center” defects. Moisture retention was higher in treated soils, with the strongest improvements observed at the highest concentrations.

Calculated final Ca content in trial
Base Soil Ca content 335 mg/kg (Hutton soil)

| | Dose added | 0.5 x | 1 x | 2 x |
|---|---|---|---|---|
| Tomatoes | Optimal Ca range | 300-500 mg/kg | | |
| | Added Ca | 42 mg/kg | 84 mg/kg | 168 mg/kg |
| | Final Ca | 377 mg/kg | 419 mg/kg | 503 mg/kg |
| Beetroot | Optimal Ca range | 1,000 to 2,000 mg/kg | | |
| | Added Ca | 60 mg/kg | 120 mg/kg | 240 mg/kg |
| | Final Ca | 395 mg/kg | 455 mg/kg | 575/kg |

FIG. 15 and FIG. 16 discloses the Nitrogen, Potassium, Calcium, Magnesium, in soil and fruits upon treatment with the presently disclosed oolitic aragonite compositions.

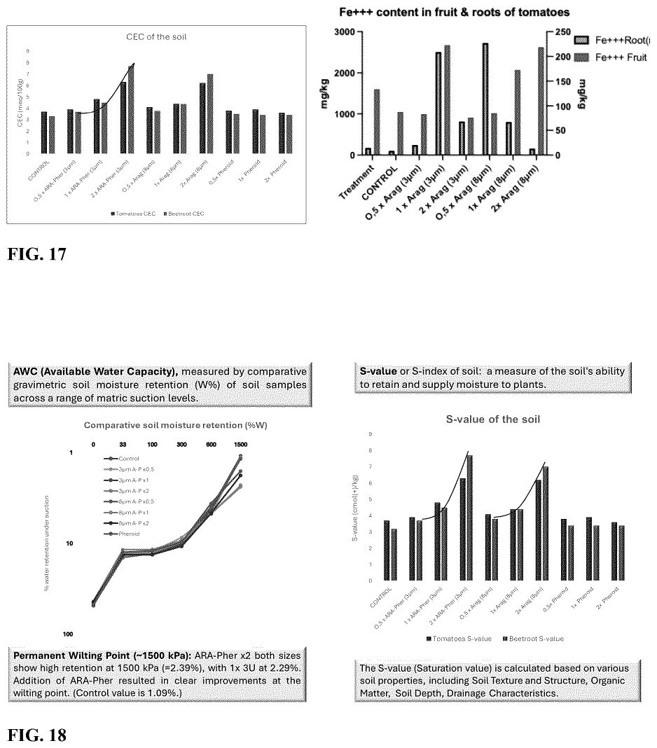

Cation Exchange Capacity (CEC) is a critical property of soil that measures the soil's ability to hold and exchange cations. CEC influences the soil's nutrient availability of soil for plants. Higher CEC means that the soil can hold more cations. FIG. 17 shows an increase in CEC of the soil upon treatment with the presently disclosed oolitic aragonite compositions. With such increase in CEC, there is also a corresponding increase in iron (Fe) content in fruits and roots of the plants.

FIG. 18 shows that the administration of the oolitic aragonite formulations improved water-retention of soil as reflected by the S-value, with the highest concentration having the best effect.

In conclusion, ARA-Pher significantly enhanced plant vigor, yield, and tissue nutrient profiles, while contributing to long-term soil health through improved ionic composition and moisture retention. Both aragonite particle size and treatment concentration influenced plant responses, and formulation stability remained adequate for effective agricultural performance. The combination of aragonite and Pheroid therefore provides a superior method for increasing calcium bioavailability and improving overall plant productivity.

In some embodiments, the numbers expressing quantities of ingredients, properties such as concentration, reaction conditions, and so forth, used to describe and claim certain embodiments of the invention are to be understood as being modified in some instances by the term “about.” As used herein, the terms “about” and “approximately”, when referring to a specified, measurable value (such as a parameter, an amount, a temporal duration, and the like), is meant to encompass the specified value and variations of and from the specified value, such as variations of +/−10% or less, alternatively +/−5% or less, alternatively +/−1% or less, alternatively +/−0.1% or less of and from the specified value, insofar as such variations are appropriate to perform in the disclosed embodiments. Thus, the value to which the modifier “about” or “approximately” refers is itself also specifically disclosed. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A method of increasing calcium concentration in a plant, the method comprising treating the plant or its soil with a composition comprising aragonite, wherein the aragonite comprises microporous oolitic aragonite particles.

2. The method of claim 1, wherein the aragonite particles have a diameter of at least 3 μm.

3. The method of claim 1, wherein the aragonite particles have a diameter of at least 8 μm.

4. The method of claim 1, wherein the composition is applied at a rate of at least 120 mL/ha.

5. The method of claim 1, wherein the composition is applied at a rate of at least 240 mL/ha.

6. The method of claim 1, wherein the treatment is periodic.

7. The method of claim 1, wherein the plant is selected from root vegetables, legumes, fruits, or grains.

8. The method of claim 1, wherein the composition comprises an aqueous solution, a mineralized composition, or a powder.

9. The method of claim 1, wherein the composition is sprayed directly onto the plant.

10. The method of claim 1, wherein the composition further comprises magnesium, a vitamin, or a soil amendment selected from fungicide, insecticide, herbicide, fertilizer, or combinations thereof.

11. A composition for increasing calcium concentration in a plant, comprising microporous oolitic aragonite particles.

12. The composition of claim 11, wherein the aragonite particles have a diameter of at least 3 μm.

13. The composition of claim 11, wherein the aragonite particles have a diameter of at least 8 μm.

14. The composition of claim 11, formulated as an aqueous solution, a mineralized composition, or a powder.

15. The composition of claim 11, further comprising magnesium, a vitamin, or a soil amendment selected from fungicide, insecticide, herbicide, fertilizer, or combinations thereof.

16. A method of growing a plant having an increased calcium concentration, the method comprising:
(a) applying a composition comprising microporous oolitic aragonite particles to a plant, wherein the oolitic aragonite particles increases the calcium content of the plant; and
(b) harvesting the plant.

17. The method of claim 16, wherein the composition is applied at a rate of at least 120 mL/ha.

18. The method of claim 16, wherein the composition is applied at a rate of at least 240 mL/ha.

19. The method of claim 16, wherein the composition is sprayed directly onto the plant.

20. The method of claim 16, wherein the composition further comprises magnesium, a vitamin, or a fertilizer.
